(19) United States
(12) Patent Application Publication
(10) Pub. No.: US 2016/0332556 A1
(43) Pub. Date: Nov. 17, 2016

(54) EASY TENT

(71) Applicant: Kevin Robertson, Fresno, CA (US)

(72) Inventor: Kevin Robertson, Fresno, CA (US)

(21) Appl. No.: 14/708,494

(22) Filed: May 11, 2015

(51) Int. Cl. B60P 7/04

(52) U.S. Cl. CPC B60P 7/04

(57) ABSTRACT

A tent assembly defining a tent portion for attachment to the bed of a pickup truck is disclosed. The tent topper has a plurality of openings therein at pre-selected locations which permit the tent to engage a plurality of adjustable pins. These pins, with their associated adjustment knobs, provide a means for stretching or making taut the tent to make the tent topper. Also, the tent portion is attached and fixed to a V-shaped roof support. Furthermore, the tent topper may be easily removed from the truck, disassembled, and stored in, for example, a suitcase type container in the truck cab behind the seat, as many truck owners do not like to permanently affix camper type shells on their truck beds.

### FIELD OF THE INVENTION

The present invention relates to a tent topper designed to fit on a truck bed. More particularly to a plurality of anchors used for mounting a camper tent to a vehicle such as a pickup truck for enjoying spontaneous fishing and road trips. The invention is also directed to a method for erecting a tent on a truck.

### BACKGROUND OF THE INVENTION

Conventional pickup trucks generally include a flat bed with sidewalls. The sidewalls often have stake receiving pockets therein. These pockets may be used, for example, to support vertical stakes utilized to retain the loads within the truck, when the loads pile higher than the sidewalls of the pickup truck.

Numerous types of camper shells and tent arrangements have been developed for mounting within such pickup trucks. Some of these are collapsible arrangements which are collapsed when the pickup truck is driven from location to location, as for example over a highway, and which are erected at a campsite for use as a camping shelter or the like. Such camper arrangements often utilize a frame which is erected in the bed of the pickup truck.

Numerous methods of attaching a camper frame to the pickup truck frame have been developed. Often these involve the utilization of stake holes, either by direct arrangement of the camper frame with a stake hole, or by engagement of the camper frame with an insert which is receivable within the stake holes or stake receiving pockets.

Conventional methods of attaching a tent frame to the vehicle body suffer numerous disadvantages. For example, often no secure anchoring method is utilized, rather the stakes are simply loosely received within the stake receiving pocket or insert. Thus, the tent would not be securely attached to the truck frame and could be easily lifted by vandals, or the weather, or perhaps by wind forces created while driving the truck a short distance with the camper erected.

In some systems, the tent frame is securely attached to the truck frame, however the method of attachment may require modification in a conventional truck frame such as by the addition of bolted on, or welded on, brackets or the like, or through the drilling of holes for the receipt of bolts or the like. Such methods suffer from being both relatively costly and inefficient, by requiring modifications in the truck frame. These modifications may be undesirable for aesthetic reasons, they may weaken or stress portions of the truck frame or body and require extensive put-up or take down procedures. Also, such methods might not readily accommodate methods of erecting camper frames which may require minor adjustment in the orientation of portions of the frame to accommodate a canvas-like covering during camper erection.

In some instances, inserts are utilized which are received within the stake receiving pockets and to which tent poles may be attached. Conventional inserts, for utilization with tent poles, generally suffer from having inadequate and inefficient means of actually securing the stake to the stake receiving pocket. Also, such inserts are difficult to assemble and have not provided adequate means to adjust positioning of the tent poles to accommodate different types of tent frames, different types of canvases, or to facilitate erection in camper.

### SUMMARY OF THE INVENTION

The present invention is for an easily storable tent topper primarily designed to cover the bed of pickup truck. By having a means for stretching taut the tent of the tent topper, the topper protects things or persons in the bed from outside weather.

The present invention relates to a tent assembly that may be attached to a pickup truck bed sidewall or anchored to the ground which overcomes the above enumerated disadvantages of prior art. The device comprises of plurality of frame members each including an inverted V-shaped roof support having pair of distal ends. Opposite side arms vertically depend from and hinged engage the distal ends of V-shaped roof support. Accordingly the side arms may freely pivot in either direction relative to the roof support. Opposite the hinge is a slide lock mechanism for locking the side arm in a fixed position relative to the roof support. Adjacent a distal end of each side arm are a pair of diametrically opposed, aligned apertures for securing the arms to an attachment or anchoring means. The frame members may be attached to the pickup truck sidewalls using attachments means.

In a preferred embodiment, a pair of tent belts which permit the tent to be tightened around the exterior sides of the pickup truck bed.

In another preferred embodiment, the tent can also include a back panel at the truck tail gate portion which can be fasten-able to the tent side panel portions by, for example, a fastening tape such as that sold under the trademark “VELCRO”.

The tent topper of the present invention is easily installable on and easily removable from a vehicle having an open bed. The tent topper comprises means to support a foldable tent; means to connect the support means to a vehicle; a foldable tent; and means, to tautly retain the tent when the support means is supporting the tent.

### BRIEF DESCRIPTION OF THE DRAWINGS

FIG. 1 is a perspective view of the tent topper of the present invention illustrating its installation on the bed of a truck;

FIG. 2 is different perspective view of the tent topper of the present invention illustrating its installation on the bed of a truck;

FIG. 3 are right and left elevational views of the tent topper in accordance with the present invention;

FIG. 4 is front view of the tent topper in accordance with the present invention; and

FIG. 5 is bottom view of the tent topper in accordance with the present invention.

### DETAILED DESCRIPTION OF THE INVENTION

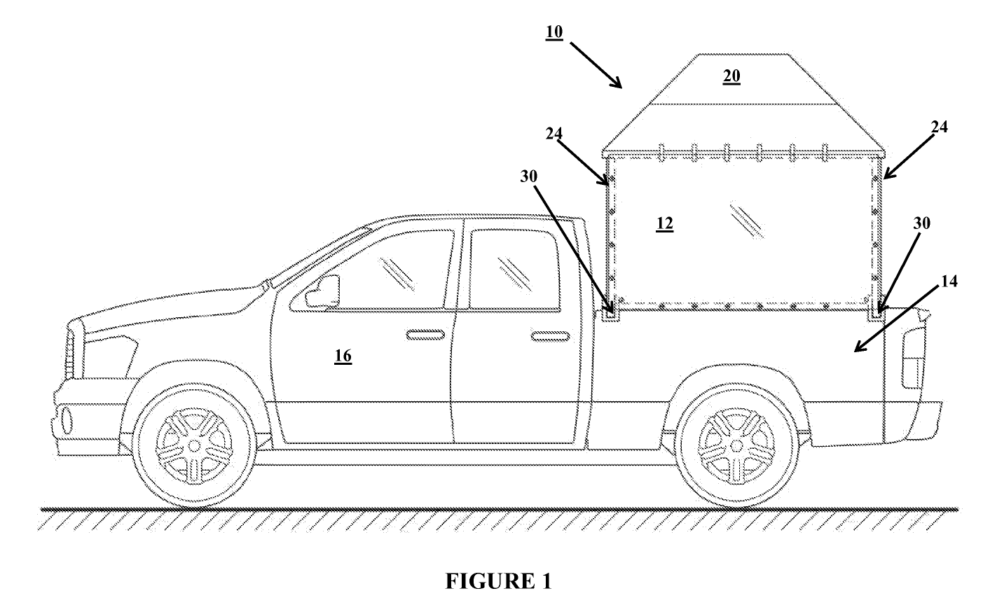

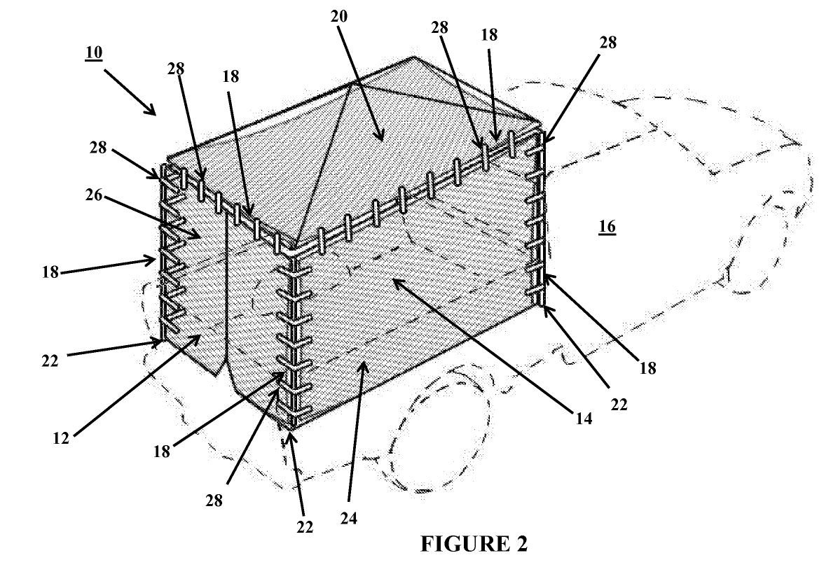

Referring now to FIGS. 1 and 2, there is shown a tent topper 10 of the present invention which is primarily designed to fit on the bed 14 of a pick-up truck 16. However by changing dimensions and/or number of the roll bar assemblies and the dimensions of the tent portion 12, the tent topper 10 may be made to fit any size truck bed 14 of any size truck 16. Also, by proper proportioning of the roll bar assembly components, the same roll bar assembly can fit a full-size pickup truck or a mini-truck. Even further, the tent topper 10 can also easily fit an open vehicle trailer or other open bed cargo type vehicle (not shown), which for example, may have an open rectangular trailer bed similar to a truck bed.

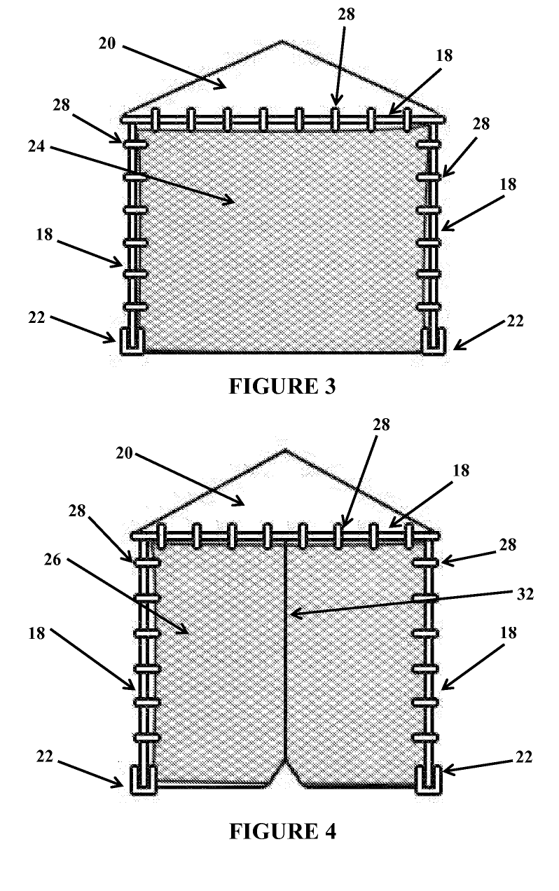

Referring now to FIGS. 2 through 4, in one preferred embodiment of the present invention a plurality of frame members 18 each including an inverted V-shaped roof support 20 having a pair of distal ends 22. The frame members 18 integrally support the tent portion 12 having a substantially pentagonal configuration when placed there around. The tent portion 12 has a pair of parallel side walls 24 and a pair of parallel end walls 26 (wherein only the front wall is shown, it should be understood that there is a parallel rear wall that is exactly similar in shape) there between and an inverted V-shaped roof 20 extending from the side and end walls, 24 and 26 respectively. Adjacent a distal edge of each sidewall 24 are a plurality of loops 28 for pulling the sidewalls 24 downwardly to tighten the tent portion 12 around frame members 18.

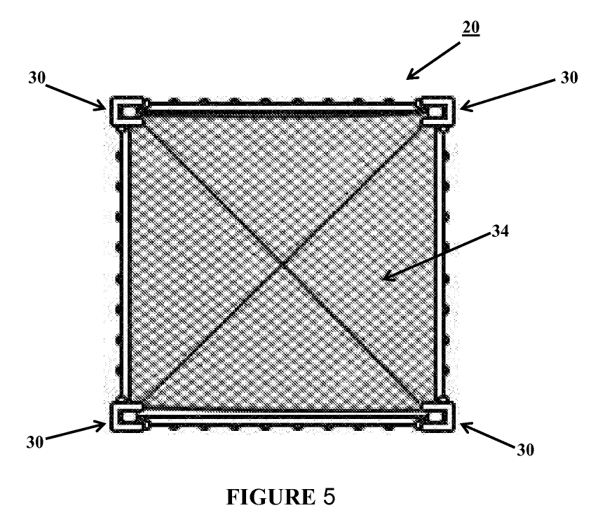

Referring now to FIGS. 1 through 5, the side 24 and end walls 26 form a canopy wherein the frame members 18 are sized to be inserted into holes 30 located at the top upper perimeter of the truck bed 14. The frame members 18 may be fabricated from light steel or aluminum. Also, as shown in FIG. 4, the front wall is shown to have a center slit 32 for ease of entry and exit as is known by tents used in the prior art. As shown in FIG. 5, the V-shaped roof 20 has a net 34 that is inside of its canvas to shield from insects; wherein Velcro straps (not shown) will hold up the canvas when user wants to adjust the netting 34.

In another preferred embodiment, the plastic covers will protect the truck holes from scratches and dings. It should be understood that the tent topper 10 of the present invention can be setup in about 15 minutes and in one preferred embodiment will have the following dimensions for short bed trucks six feet by six feet by four feet high and for long trucks will be six feet by eight feet by four feet high. In yet another preferred embodiment, the invention may have a plastic cover over the top half of the tailgate and top of the truck bed with tension bolts (not shown) to hold in place if needed.

In summary, a pickup truck tent assembly or tent topper 10 has been described which may be easily attached to the side walls 24 of a pickup truck bed 14 and which may be easily collapsed for transport or storage. In accordance with the preferred embodiments of the present invention, the pickup truck tent assembly or tent topper 10 is uniquely configured by defining a plurality of frame members 18 that allow the entire structure to be completely collapsed and folded in a matter of seconds and with minimal effort.

Although specific embodiments have been illustrated and described herein, it will be appreciated by those of ordinary skill in the art that any arrangement, which is calculated to achieve the same purpose, may be substituted for the specific embodiment shown. This application is intended to cover any adaptations or variations of the present invention. Therefore, it is manifestly intended that this invention be limited only by the claims and the equivalents thereof. Although the invention has been explained in relation to its preferred embodiment, it is to be understood that many other possible modifications and variations can be made without departing from the spirit and scope of the invention.

What is claimed is:

1. A tent assembly for attachment to a bed of a pickup truck, comprising:
a tent portion defined by a plurality of frame members wherein said frame members define side and end walls thereby forming a tent topper;
said tent topper further supporting an inverted V-shaped roof having a pair of distal ends;
opposite side arms vertically depending from and hingedly engaging said distal ends of V-shaped roof support wherein said side arms may freely pivot in either direction relative to said roof support for attaching said tent assembly to the bed of a pickup truck.

2. The tent assembly according to claim 2, further including opposite said hinge side arm, a slide lock mechanism for locking said side arm in a fixed position relative to said roof support.

3. The tent assembly according to claim 3, wherein adjacent a distal end of each said side arm are a pair of diametrically opposed, aligned apertures for securing said arms to an attachment or anchoring means wherein said frame members may be attached to the pickup truck sidewalls.

4. The tent assembly according to claim 1, wherein said V-shaped roof includes a net that is inside of its canvas to shield from insects wherein Velcro straps hold up said canvas when a user wants to adjust said netting.

5. The tent assembly according to claim 1, wherein said tent topper has a dimension of six feet by six feet by four feet high.

6. The tent assembly according to claim 1, wherein said tent topper has a dimension of six feet by eight feet by four feet high.
